(19) United States
(12) Patent Application Publication
(10) Pub. No.: US 2005/0187994 A1
(43) Pub. Date: Aug. 25, 2005

(54) Computing device capable of time sorting and its control method

(75) Inventors: Ming-Wei Juang, Taipei (TW); Chih-Cheng Chien, Taipei (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 10/782,957

(22) Filed: Feb. 23, 2004

(51) Int. Cl. G06F 13/00

(52) U.S. Cl. 708/160

(57) ABSTRACT

A computing device capable of time sorting and its control method are disclosed, wherein a clock is embedded in the computing device for providing corresponding time parameters so as to sort and sum up the inputted income/expense values to be saved according to time parameters. Further, the summation of income values or expense values can be computed and displayed according to different time periods, such as the summation that occurred during each past day, each past week, each past month, each past season, each past year, etc.

### BACKGROUND OF THE INVENTION

1. Field of the Invention

The present invention relates to a computing device capable of time sorting and its control method, which is used in electronic equipment capable of clocking, inputting, displaying, and computing.

2. Description of Related Art

Currently, the conventional computing device, such as a calculator, provides a convenient way for users to process calculations with its rapid and correct computing ability. However, the conventional calculator can only execute an expression inputted by the user, and then output the resulted value of the expression without saving the resulted value, sorting the saved value according to time or other purposes, or even accumulating income or expense values to obtain a balance. Therefore, when a user tends to keep account by utilizing the conventional calculator, for example, to compute an income summation and an expense summation that occurred during the past week, the user has to classify values as income values and expense values manually before one by one keying in those income/expense values that occurred during the past week for obtaining the income/expense summation. Thus, it is getting more inconvenient, time-consuming, and error-prone for users to classify income/expense values and compute income/expense summation that occurred during a longer period of time, such as the past month, the past season, or even the past year.

Therefore, it is desirable to provide an improved computing device capable of time sorting and its control method to mitigate and/or obviate the aforementioned problems.

### SUMMARY OF THE INVENTION

A main object of the present invention is to provide a computing device capable of time sorting and its control method, which provides a clocking function to automatically accumulate values according to different time classifications, and to compute the summation of saved values that occurred during different time periods (for example, during each past day, each past week, each past month, each past season, each past season, etc.) so as to improve the usage convenience.

Another objective of the present invention is to provide a computing device capable of time sorting and its control method, which saves income values and expense values in accordance with their corresponding classification, and automatically computes the income summation and expense summation that occurred during a specific time period without manually classifying and keying in those values for further computation. Therefore, reliability and correctness can be improved to eliminate manual mistakes.

A further objective of the present invention is to provide a computing device capable of time sorting and its control method, which provides a time-sorting design according to the efficiency of each computing device itself. For example, income/expense values that occurred during the same day are saved in the same field of the memory without separately saving each income/expense value so as to save the memory space and to lower the cost of the computing device.

To achieve the object, the computing device capable of time sorting of the present invention includes a display module, an input module, a memory, a clock, and a microprocessor. The display module displays values. The input module is capable of inputting, and has at least one save key for saving the value display in the display module, and at least one summation key for computing a saved value. The memory saves the value received from the input module after the at least one save key is pressed. The clock is embedded in the computing device of the present invention for providing a corresponding time parameter while the memory saves the value. The microprocessor receives a save command after the save key of the input module is pressed, controls the memory to save the value in conjunction with the corresponding time parameter provided by the clock according to the save command, and receives a summation command after the summation key of the input module is pressed for computing a summation of the value saved in the memory.

According to another aspect of the present invention, a control method applied in the above-mentioned computing device capable of time sorting firstly receives an input command, and then displays a value after the input command is executed. Next, a save command is received for saving the inputted value in conjunction with a corresponding time parameter in a memory. When a summation command is received, a summation, such as an income summation or an expense summation, of the value saved in the memory can be computed.

Further, the at least one save key of the present invention comprises an income key and an expense save key for computing the income summation and the expense summation. The summation of the values saved in the memory that occurred during a specific time period, such as during each past day, each past week, each past month, each past season, and each past year, is computed after the at least one summation key is pressed.

Other objects, advantages, and novel features of the invention will become more apparent from the following detailed description when taken in conjunction with the accompanying drawings.

### BRIEF DESCRIPTION OF THE DRAWINGS

FIG. 1 is a front view of a computing device capable of time sorting according to a preferred embodiment of the present invention;

FIG. 2 is a block diagram of the computing device capable of time sorting according to the preferred embodiment of the present invention;

FIG. 3 is a flowchart for inputting income/expense values according to the preferred embodiment of the present invention;

FIG. 4 is a flowchart for displaying income/expense values according to the preferred embodiment of the present invention; and

FIG. 5 is a front view of a computing device capable of time sorting according to another preferred embodiment of the present invention.

### DETAILED DESCRIPTION OF THE PREFERRED EMBODIMENT

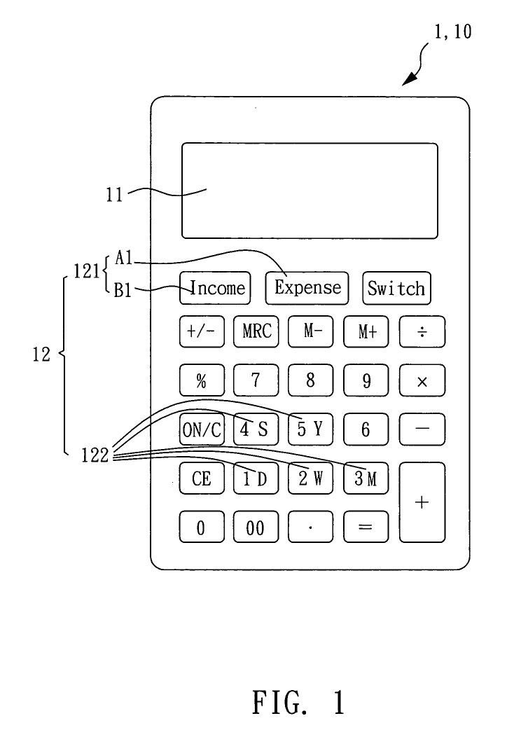

Please refer to FIG. 1. FIG. 1 is a perspective view of a computing device according to a preferred embodiment of the present invention. The computing device 1 is a calculator 10 capable of time sorting. The computing device 1 can also be a printing calculator, a data bank, an electronic dictionary, a personal digital assistant (PDA), or any other electronic equipment capable of clocking and computing without restriction of the calculator 10 of the present embodiment. As shown in FIG. 1, the appearance of the calculator 10 includes a display module 11 and an input module 12. The input module 12 comprises number keys and operator keys, and it further comprises a set of save keys 121 and a set of summation keys 122.

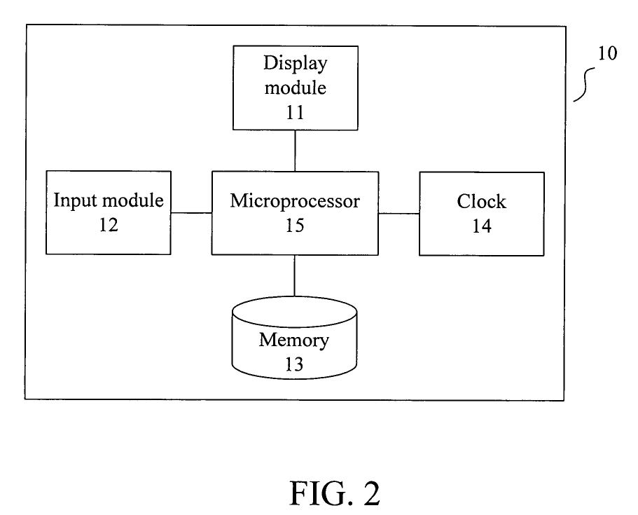

With reference to FIG. 2, there is shown a block diagram of the calculator 10 of the present embodiment. The calculator 10 includes the display module 11, the input module 12, a memory 13, a clock 14, and a microprocessor 15. The display module 11 is used for displaying. The input module 12 is capable of inputting, for example, for simply inputting a value, or continuously inputting a series of values and operators to form an expression, and then a resulted value is computed by the microprocessor 15 according to the expression. In particular, one of the save keys 121 of the input module 12 is defined as an income save key A1, and the other one is defined as an expense save key B1. The summation keys 122 share some buttons with the number keys, and each summation key 122 is defined as different time period, where “D” represents “day”, “W” represents “week”, “M” represents “month”, “S” represents “season”, and “Y” represents “year”. The “Switch” key is used for switching the corresponding function of the number key and the summation key 122. The memory 13 is preferred to be a random access memory (RAM) for saving values. In this embodiment, the memory 13 defines an income save unit (field) for saving income values, and an expense save unit for saving expense values.

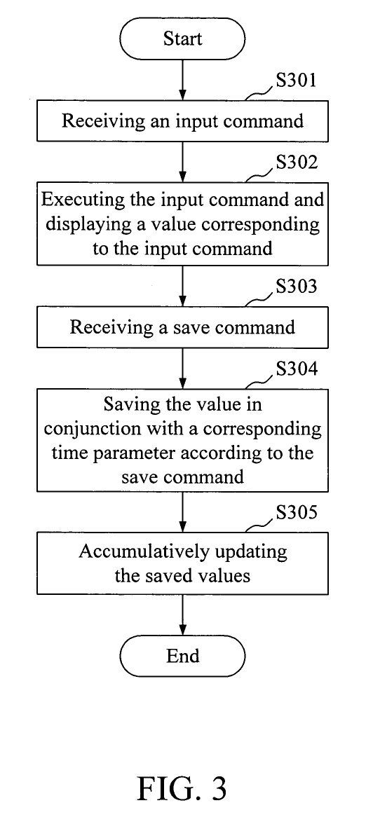

Due to the facility of keeping account by utilizing a calculator to compute the summation of income and expense for further obtaining the balance, the calculator 10 of this embodiment as shown in FIG. 3 firstly receives an expression or a value (i.e. input command) inputted via the input module 12 by a user (step S301). The microprocessor 15 executes the input command to obtain a resulted value (step S302). If the resulted value represents an income value, the income save key A1 of save keys 121 is then pressed to generate a save command (step S303). Thus the microprocessor 15 saves the value in conjunction with a corresponding time parameter provided by the clock 14 in the income save unit of the memory 13 according to the save command (step S304), and then accumulatively updates today's income value (step S305). Accordingly, if the resulted value represents an expense value, the expense save key B1 is pressed to save the value in the expense save unit, and the microprocessor 15 accumulatively updates today's expense value (from step 303 to step S305).

The income save unit and expense save unit save income values and expense values in corresponding fields. In this embodiment, each field of the income save unit and expense save unit saves values that occurred during “each day” according to its time parameter. That is, each day is defined with a corresponding income save field for saving income values that occurred during the day, and a corresponding expense save field for saving expense values that occurred during the day without separately saving each income and expense value so as to obviously save the space of the memory 13. The memory 13 can also one by one save all of the income and expense values as long as it has enough space. Furthermore, the memory 13 of this embodiment is defined to save income values and expense values that occurred only during the past 90 days. Therefore the preceding income and expense save fields will be sequentially replaced by the newly occurred income values and expense values after the 91st day. In case the memory 13 has a larger space, it can expand its save fields to save more values.

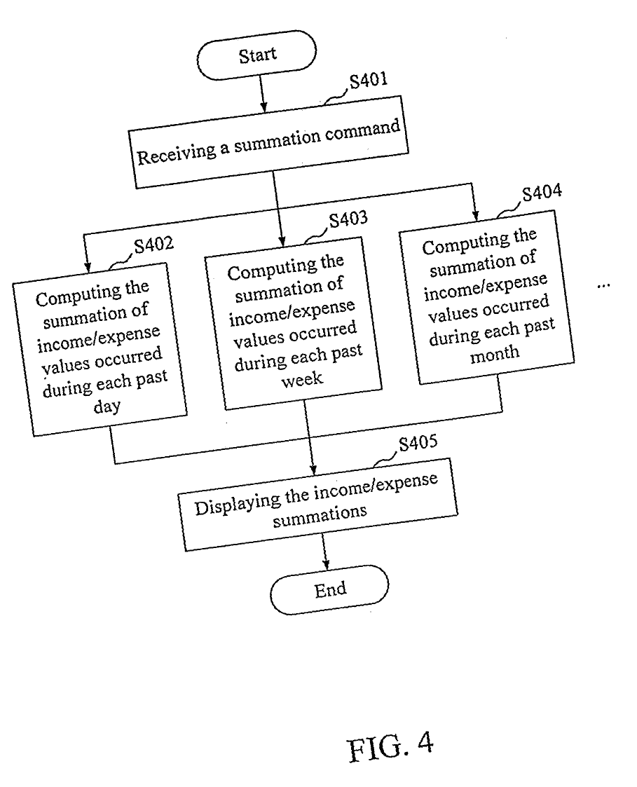

Please refer to FIG. 4. FIG. 4 is a flowchart for displaying the income/expense summation according to this embodiment. For example, the microprocessor 15 receives a summation command after the summation key 122 “D” corresponding to the button of number key “1” is pressed (step S401). The microprocessor 15 then computes the income summation of each past day from the income save unit of the memory 13, and the expense summation of each past day from the expense save unit (step S402). Next, the income summation or the expense summation of each past day can be displayed in the display module 11 (step S405). The microprocessor 15 of the embodiment computes everyday income/expense summations occurred during the past 31 days as a basis of a month. The user uses the selection key, such as the up/down arrow key (not shown), to select the income/expense summation according to requirements. Moreover, the microprocessor 15 also computes a balance by subtracting the income summation from the expense summation. It is noted that the computing efficiency of the microprocessor 15 is designed according to a practical requirement that is not limited in this embodiment.

In the same way, if the summation key 122 “W” corresponding to the button of number key “2” is pressed to generate another summation command (step S401), the microprocessor 15 computes the income summation and the expense summation of each past week (step S403). Similarly, the user also uses the selection key to select the required income/expense summation to be displayed in the display module 11 (step S405). While the summation key 122 “M” corresponding to the button of number key “3” is pressed (step S401), the microprocessor 15 computes the income summation and the expense summation of each past month (step S404) to be displayed in the display module 11 (step S405). According to the above-mentioned embodiment, the microprocessor 15 can compute the summation of income/expense values that occurred during each past day, each past week, each past month, each past season, or even each past year according to the definition of the summation key 122 being pressed.

The microprocessor 15 of this embodiment defines that each past week counts from Sunday, each past month counts from the first day of each month, each past season counts from the first day of each season, and each past year counts from January 1. Of course the microprocessor 15 can define that the past week covers the previous 7 days, the past month covers the previous 30 days, the past season covers the previous 90 days, etc.

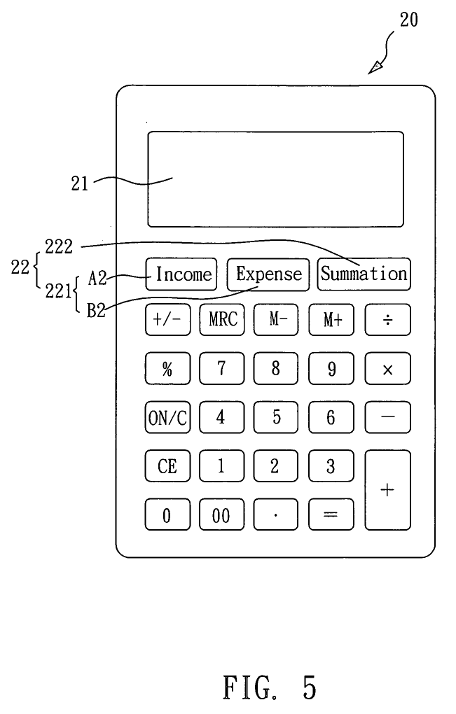

With reference to FIG. 5, there is shown a perspective view of the computing device according to another preferred embodiment of the present invention. In this embodiment, the summation key 222 of the calculator 20 is a multi-functional key, wherein the summation of the past day is obtained after the summation key 222 is pressed once, the summation of the past week is obtained after the summation key 222 is pressed twice, and so on. Each input key of the input module 22 is designed as a multi-functional key or an independent key depending on the size of the computing device.

According to the aforementioned embodiments, the computing device of the present invention automatically sorts saved values according to its corresponding time parameter or purpose, and computes the summation of saved values by selecting saved values that occurred from the group of: each past day, each past week, each past month, etc. Therefore the usage convenience is improved. Further, the present invention classifies values as income values and expense values, separately saves income values and expense values according to corresponding time parameters, and automatically computes the balance by subtracting the income summation from the expense summation for eliminating manual errors.

Although the present invention has been explained in relation to its preferred embodiment, it is to be understood that many other possible modifications and variations can be made without departing from the spirit and scope of the invention as hereinafter claimed.

1. A computing device capable of time sorting, comprising:
a display module for displaying a value;
an input module for inputting, and having at least one save key for saving the value displayed in the display module, and at least one summation key for computing a saved value;
a memory for saving the value received from the input module after the at least one save key being pressed;
a clock for providing a corresponding time parameter while the memory is saving the value; and
a microprocessor for receiving a save command after the save key of the input module being pressed, controlling the memory to save the value in conjunction with the corresponding time parameter provided by the clock according to the save command, and receiving a summation command after the summation key of the input module being pressed for computing a summation of the value saved in the memory.

2. The computing device as claimed in claim 1, wherein the at least one save key of the input module comprises an income save key for saving an income value displayed in the display module in the memory, and an expense save key for saving an expense value displayed in the display module in the memory.

3. The computing device as claimed in claim 2, wherein the memory defines an income save unit for saving the income value, and an expense save unit for saving the expense value.

4. The computing device as claimed in claim 1, wherein a summation of the values saved in the memory that occurred during a specific time period is computed after the summation key is pressed, where the specific time period is selected from the group of: each past day, each past week, each past month, each past season, and a year.

5. The computing device as claimed in claim 1, wherein the at least one summation key of the input module is a multi-functional key.

6. The computing device as claimed in claim 1, wherein the memory is a random access memory (RAM).

7. A control method of a computing capable of time sorting, comprising the steps of:
(A) receiving an input command;
(B) executing the input command and displaying a value corresponding to the input command;
(C) receiving a save command for saving the value; and
(D) saving the value in conjunction with a corresponding time parameter in a memory according to the save command.

8. The control method as claimed in claim 7, wherein the memory defines an income save unit for saving an income value, and an expense save unit for saving an expense value, and the value to be saved according to the save command being selected from the group of: the income value and the expense value.

9. The control method as claimed in claim 7, further comprising the steps of:
(E) receiving a summation command; and
(F) computing a summation of the value saved in the memory according to the summation command.

10. The control method as claimed in claim 9, wherein step (F) computes the summation of the value saved in the memory that occurred during a specific time period which is selected from the group of: each past day, each past week, each past month, each past season, and a year.
